(19) United States
(12) Patent Application Publication
(10) Pub. No.: US 2007/0194057 A1
(43) Pub. Date: Aug. 23, 2007

(54) BEVERAGE FLAVOR PRESERVER DEVICE AND METHOD

(75) Inventor: John P. Gehl, Germantown, WI (US)

Correspondence Address: BELL, BOYD & LLOYD, LLP, P.O. Box 1135, CHICAGO, IL, 60690, US

(73) Assignee: Gehl's Guernsey Farms, Inc., Germantown, WI (US)

(21) Appl. No.: 11/677,256

(22) Filed: Feb. 21, 2007

Related U.S. Application Data
(60) Provisional application No. 60/775,102, filed on Feb. 21, 2006.

(51) Int. Cl. G01F 11/00; B65D 88/34

(52) U.S. Cl. 222/386; 220/216; 222/390

(57) ABSTRACT

A beverage flavor preserver is provided for use in conjunction with a beverage dispenser or beverage container. The flavor preserver is locatable substantially at the level of the beverage surface and covers at least a portion of the beverage surface. The flavor preserver reduces flavor loss of the beverage.

### PRIORITY CLAIM

This application claims priority to, and the benefit of, U.S. Provisional Application No. 60/775,102 filed on Feb. 21, 2006, the entire contents of which is incorporated herein by reference.

### BACKGROUND

Many restaurants and other eateries produce fresh brewed beverages, such as tea and coffee, on site. After brewing, the eatery pours the fresh-brewed beverage into a tank with a lid. The beverage remains in the tank throughout the day as workers dispense servings to the patrons.

One disadvantage with this approach is that the beverage can lose a significant amount of flavor and freshness while stored in the tank. This loss in flavor can be caused by the exposure of the beverage to the air and oxygen in the closed tank or other chemical factors. As the level of beverage falls in the tank, the volume of the air between the beverage surface and the lid increases affecting the reaction with the atmosphere. In addition, increased exposure to the air in the closed tank can increase the risk of beverage spoilage, bacteria growth and the like.

Therefore, there is a need to overcome the disadvantages described above or otherwise lessen the effects of such disadvantages.

### SUMMARY

Embodiments of the present disclosure provide a flavor preserver device for use with a beverage container, including, but not limited to, the beverage reservoir of a beverage dispenser. The flavor preserver provides a physical or chemical barrier between the beverage and the air above the beverage. In operation, the flavor preserver is inserted into a beverage container and is positioned near or floats atop the beverage surface. The flavor preserver is movable to correspond with a changing beverage level. Therefore, the flavor preserver reduces the exposure of the beverage to the air in the beverage container. Accordingly, the flavor preserver reduces the risk of flavor loss, beverage spoilage and the like.

### BRIEF DESCRIPTION OF THE FIGURES

FIG. 1 is a diagrammatic perspective view of the flavor preserver housed in a beverage dispenser according to one embodiment.

FIG. 2 is an enlarged diagrammatic side view of a disk-shaped flavor preserver housed in a beverage dispenser according to one embodiment.

FIG. 3 is an enlarged diagrammatic side view of a disk-shaped flavor preserver with an o-ring housed in a beverage dispenser according to one embodiment.

FIG. 4 is a perspective view of a circular flavor preserver according to one embodiment.

FIG. 5 is a perspective view of a rectangular or elliptical flavor preserver according to one embodiment.

FIG. 6 is a perspective view of a square-shaped flavor preserver according to one embodiment.

FIG. 7 is a diagrammatic perspective view of the flavor preserver housed in a beverage dispenser having a drive mechanism according to one embodiment.

FIG. 8 is an enlarged diagrammatic side view of a discrete element flavor preserver housed in a beverage dispenser according to one embodiment.

FIG. 9 is a top view of a discrete element flavor preserver housed in a beverage dispenser according to one embodiment.

### DETAILED DESCRIPTION

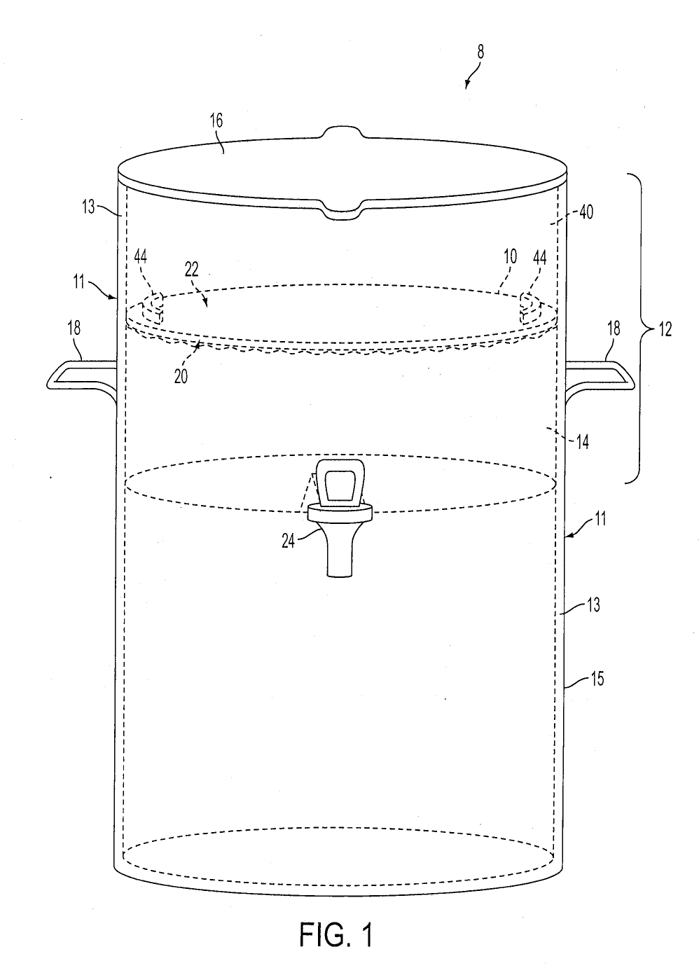

Referring now to the drawings, FIG. 1 illustrates one embodiment of a beverage apparatus or dispenser 8 having a beverage surface cover or flavor preserver 10. In the example embodiment, the beverage dispenser 8 has a housing 11 which has a wall thickness 13. The housing 11 has an open-ended base 15 which supports a beverage reservoir or container 12 sized to hold a beverage 14. The open-ended base 15 defines a hollow space and supports the beverage container 12 and lid 16 at an elevated position. In other embodiments, the open-ended base 15 may be legs or another supporting device.

In the following examples, the described beverage is tea. However, it should be appreciated that the beverage 14 may be a brewed beverage such as coffee, tea, beer, a non-brewed beverage such as juice, water or soda, or any other beverage that is subject to loss of flavor or nutrient after being brewed or produced. The beverage can also be a liquid food such as soup.

The beverage dispenser 8 also includes a top cover 16 and two carrying handles 18. The beverage dispenser 8 is illustrated to be cylindrical. However, it should be appreciated that the beverage dispenser 8 may be oval shaped, rectangular, square, or of any other suitable shape. Also, the beverage dispenser 8 may be a tea dispenser, a coffee machine, or other dispenser capable of dispensing the beverages mentioned above.

In one embodiment, after an operator produces or brews a beverage 14 using a production or brewing apparatus (not shown), the operator removes the cover 16 and pours the beverage 14 into the beverage container 12 until it is substantially full (i.e., the beverage level rises to the top). Alternatively, the beverage dispenser 8 may be placed beneath a production or brewing apparatus (not shown) such that the beverage container 12 fills while the beverage 14 is being produced or brewed. After the beverage 14 is delivered or poured into the dispenser 8, the operator inserts the flavor preserver 10 in the beverage container 12 and replaces the top cover 16. Alternatively, the flavor preserver 10 may be semi-permanently or permanently housed in the beverage dispenser 8 such that the beverage container 12 may be filled while the flavor preserver 10 is housed inside. In such an example, as the operator pours the beverage into the beverage container 12, the flavor preserver tips to one side or allow the beverage to slide between a gap between the sidewall of the beverage container 12 and the edges of the flavor preserver 10. In either case, after pouring, the operator dispenses the beverage 14 through an outlet 24. In the example illustrated in FIG. 1, the outlet 24 is a spring loaded valve assembly mounted near the mid-section of the beverage dispenser 8. This mid-section positioning of the outlet 24 enables a user or operator to place a cup or other beverage holding device beneath the outlet 24 during beverage dispensation. However, it should be appreciated that any suitable type of outlet valve or mechanism may be used, and may be located closer to the top or bottom of the beverage dispenser 8.

In one embodiment, the use or operation of the flavor preserver increases the flavor retention time of the brewed beverage (i.e., slows or retards the rate of flavor loss). The method includes brewing a beverage, pouring the brewed beverage into a beverage container, inserting a removable flavor preserver onto or about the surface of the brewed beverage, and dispensing the brewed beverage to one or more consumers. It should be appreciated that the flavor preserver may be a physical barrier such as a piston or a gas or other chemical barrier, as described in further detail below. Also, it should be appreciated that the flavor preserver can be various shapes, sizes, forms, or any suitable physical configuration that enables a substantial portion of the beverage surface to be covered or separated from the atmosphere.

In an embodiment, the flavor preserver functions as an oxidation reducer. In this embodiment, the flavor preserver reduces the amount or extent of an oxidation reaction between the beverage and the air enclosed in the head space 40 above the beverage.

1. Buoyant Piston

Referring to FIG. 1, in one embodiment, the flavor preserver 10 is in the form of a movable piston. In one example, the flavor preserver 10, in the form of a piston, is generally flat and disk shaped to accommodate the shape of the beverage container 12. That is, the cross-sectional profile of the flavor preserver 10 is designed to be substantially similar to the cross-sectional profile of the beverage container 12. The flavor preserver 10 has an upper surface 22 and a lower surface 20. The flavor preserver 10 is made of one or more materials that have a buoyancy property such that the flavor preserver 10 at least partially floats or remains suspended on the surface of the liquid beverage 14. Buoyancy can be described as the upward force on an object produced by the surrounding fluid (i.e., a liquid or a gas) in which it is fully or partially immersed, due to the pressure difference of the fluid between the top and bottom of the object. In the present embodiments, the net upward buoyancy force produced by the beverage 14 is substantially equal to the weight of the flavor preserver 10. This buoyancy force enables the flavor preserver 10 to at least partially float on the surface of the beverage 14. Therefore, in this embodiment, the lower surface 20 of the piston shaped flavor preserver 10 is at least partially submerged in or engaged with the liquid beverage 14. The piston shaped flavor preserver 10 may be made out of any suitable plastic, polymer or other material that has an appropriate buoyancy property and that is suitable for use with a consumable food product. Also, it should be appreciated that the flavor preserver 10 may not be flat or disc shaped. However, the flavor preserver 10 should generally be shaped in such a manner as to cover a substantial portion of the beverage surface. Therefore, the flavor preserver 10 provides a physical barrier between at least a portion of the beverage surface and the air or atmosphere between the cover 16 and the top 22 of the flavor preserver 10.

In one embodiment, the flavor preserver 10 includes one or more grippers 44 on the top 22 of the flavor preserver 10, as illustrated in FIG. 1. In this embodiment, the grippers 44 assist the user in grasping, inserting and removing the flavor preserver 10 with respect to the dispenser 8. Each gripper 44 has a protruding wall. It should be appreciated, however, that the gripper 44 can have any suitable shape.

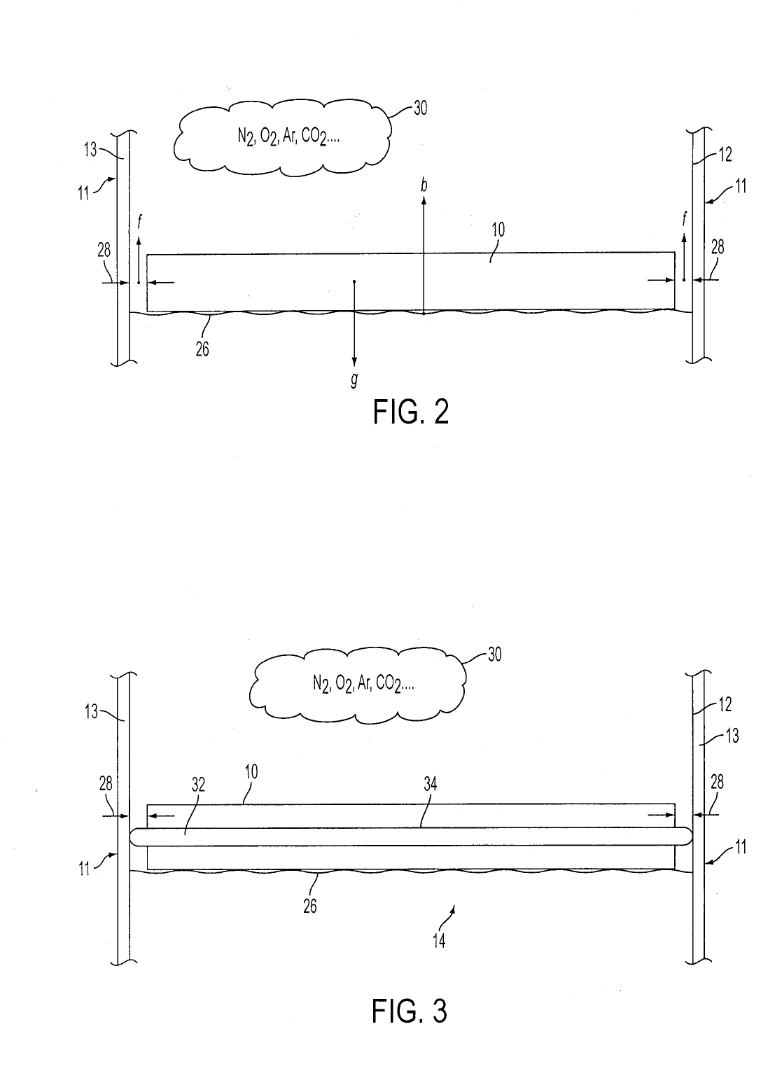

Referring now to FIG. 2, the flavor preserver 10 has a width or a diameter that is slightly smaller than the inside width or diameter of the beverage container 12. This leaves a small gap 28 around the perimeter of the flavor preserver 10 and between the inside wall of the beverage container 12. Therefore, the flavor preserver 10 is substantially free to move up and down in the beverage container 12 and is also is able to cover most of the surface area 26 of the exposed beverage, thus reducing the exposure of the beverage 14 to the atmosphere 30 in the head space 40 above.

As a user or operator dispenses the beverage 14 through the outlet valve 24, the liquid level in the beverage container 12 falls. Likewise, as the operator pours additional beverage into the beverage container 12, the liquid level rises. In one embodiment, the flavor preserver 10 is designed with a mass sufficient to allow the flavor preserver 10 to fall with a falling liquid level. Several forces act upon the flavor preserver 10 when the liquid level rises or falls. These forces include at least a gravitational force (g), a buoyancy force (b), and frictional forces (f). Frictional forces (f) are the forces that oppose the relative motion or tendency toward such motion between the housing 11 of the beverage container 12 which is in contact with the side wall of the flavor preserver 10. The buoyancy force (b) is the upward force on the flavor preserver 10 produced by the surrounding liquid.

As illustrated in FIG. 2, as the liquid level raises, the buoyancy force (b) acting upward on the flavor preserver 10 is greater than the sum of the gravitational force (g) and the frictional force (f), each of which acts downward on the flavor preserver 10. Accordingly, the disk or flavor preserver 10 will rise with a rising liquid level. Although the edges of the flavor preserver 10 are illustrated to be flat, the edges may be curved or of any suitable profile to facilitate the upward and downward sliding movement.

In one embodiment, as illustrated in FIG. 3, the flavor preserver 10 includes an annular groove 34 around its perimeter to accommodate an o-ring 32 or other suitable sealing member. The o-ring functions primarily to close the gap 28 between the flavor preserver 10 and the inner wall of the beverage container 12, and to generate a partial, substantial or complete seal between the beverage 14 and the atmosphere 30 above. Therefore, the use of the o-ring 32 facilitates a further reduction in flavor loss of the beverage 14. The o-ring 32 may be made of rubber, polymer or any other suitable material that enables the flavor preserver 10 to slide or travel up and down with respect to a changing beverage level. Moreover, it should be appreciated that any suitable sealing ring or mechanism may be used and may be integrally incorporated into or formed with the flavor preserver 10.

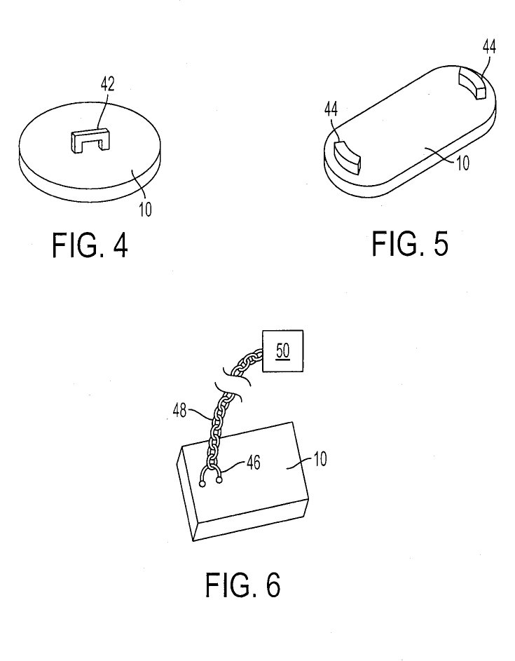

As illustrated in FIGS. 4-6, the flavor preserver 10 may be circular, oval, square or of any other suitable shape in order to substantially accommodate the profile of the beverage dispenser, as described above. In an embodiment, as illustrated in FIG. 4, the flavor preserver 10 includes a handle 42 to facilitate insertion and removal of the flavor preserver 10 from the beverage container 12. In another embodiment, as illustrated in FIG. 5, the flavor preserver 10 includes one or more grippers 44, as described above with reference to FIG. 1. In another embodiment, as illustrated in FIG. 6, the flavor preserver 10 includes a tipper 50 coupled to the flavor preserver by a line, chord, rod or chain 48 and a coupler 46. In this embodiment, the operator moves the tipper 50 to raise or lower or tip the flavor preserver 10. This may be done when inserting or removing the flavor preserver 10. Also, the operator may tip the flavor preserver 10 with the tipper 50 when adding additional beverage to the beverage container 112. Therefore, when adding beverage, the tipper 50 creates a gap or passage to facilitate the flow of the beverage around and under the flavor preserver 10. It should be appreciated that the handle 42, the grippers 44, and the tipper 50 can be included on any of the differently shaped flavor preservers 10 shown in FIGS. 4-6.

2. Mechanically Actuated Piston-Shaped Flavor Preserver with Fluid Level Sensor

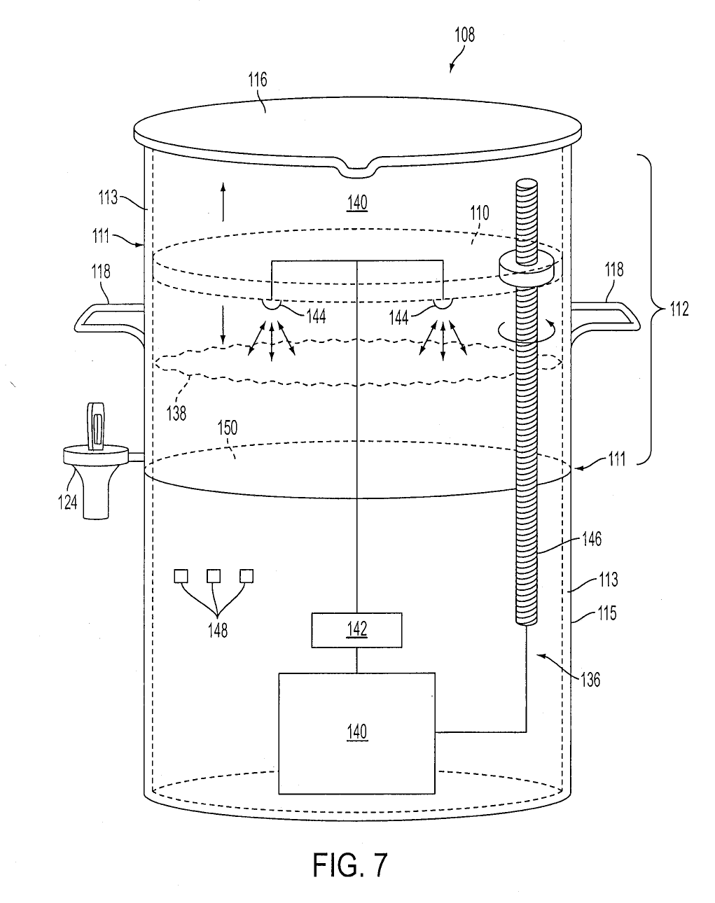

In one embodiment, the beverage dispenser 108 includes a flavor preserver 100 in the form of a piston, where the piston is mechanically coupled to a drive mechanism 136. The drive mechanism 136 controls for the vertical movement of the piston shaped flavor preserver 110 as the liquid level 138 changes. As shown in FIG. 7, the drive mechanism 136 causes the flavor preserver 110 to move up and down. The drive mechanism 136 may be any of a large variety of different drive devices. For example, as shown in FIG. 7, drive mechanism 136 includes a motor 140 which rotates a vertically positioned worm gear 146. The flavor preserver 110 may be attached to worm gear 146 by a bracket (not shown) that is attached to a fastener (not shown) threaded on the worm gear 136. In one embodiment, the drive mechanism 136 includes one or more sensors 144 enabling the controller 142, or other control mechanisms (not shown), to detect the position of flavor preserver 110 relative to the liquid level 138. The sensors 144 may be light sensors, liquid sensors, pressure sensors, sonar sensors or may be based on any other suitable liquid level sensing technology.

In one example, the beverage dispenser includes a motor 140 that is controlled by a processor or controller 142. The flavor preserver 110 may operate in a manual mode or in an automatic mode. In the manual mode, a user inputs a level change and the processor 142 causes the drive mechanism 136 to raise or lower the flavor preserver 110 by a specified amount. In an automatic or semi-automatic mode, the flavor preserver 110 includes one or more sensors 144 that detect the level 138 of the fluid in the beverage container 112. Alternatively, the sensors 114 may be located on the base of the beverage container 112 and may sense upwardly through the liquid to determine the height of the liquid.

In this manner, the sensors send information to the processor or controller 142 and then the controller 142 causes the motor 140 to activate the drive mechanism 136. Therefore, the sensors 144 provide information that causes the drive mechanism 136 to raise or lower the flavor preserver 110 to accommodate the changing fluid level as the beverage is ultimately dispensed. Accordingly, there is a method for automatically or semi-automatically reducing exposure of the beverage to the atmosphere in the head space 140 above the beverage. Accordingly, the amount of flavor reduction can be reduced.

In one embodiment, the beverage dispenser includes a viewing window (not shown) enabling a consumer or operator to view both the liquid level and the movable flavor preserver 10. Therefore, the beverage dispenser can indicate that although the beverage level may be low, the beverage is nevertheless retained in a fresh or relatively fresh state through use of the flavor preserver 110.

3. Flavor Preserver Formed from a Plurality of Discrete Elements

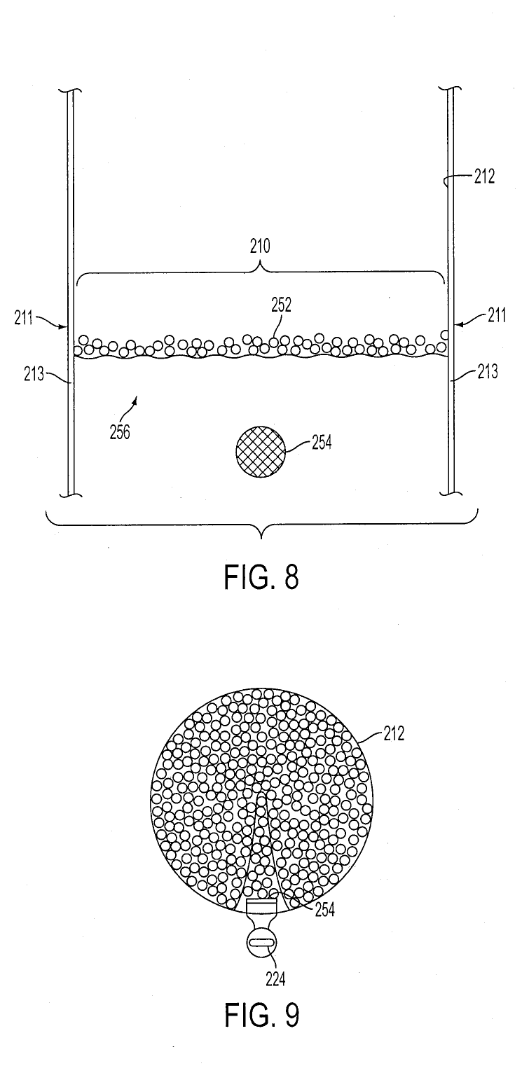

In another embodiment as illustrated in FIGS. 8 and 9, the flavor preserver 210 includes a plurality of beads or discrete elements 252 introduced or poured into the beverage container 212. In the example illustrated in FIG. 8, the elements 252 include a plurality of beads such as polystyrene beads. In practice, a sufficient amount of beads 252 would be poured into the beverage container 212 with the liquid 256 and would at least partially align to form a substantially uniform layer. This particular type of flavor preserver 210 enables an operator to refill the beverage container 212 without having to first remove the flavor preserver 210. For example, when an operator pours beverage into the beverage container 212, the force of pouring may move or stir the beads 252. After the beverage settles, the beads 252 form into a generally uniform flavor preserver 210 layer on top of the beverage surface. It should be appreciated that the material for the discrete flavor preserver 210 elements is not limited to the above polystyrene example and may instead include any suitable buoyant material, such as plastics, rubber, or other polymers suitable for use in a consumable product which would generally self arrange themselves to form a substantially uniform layer. In one embodiment, the discrete element flavor preserver 210 may form the shape of the beverage container 212, whether the beverage container 212 has a rectangular, circular, cylindrical, or other shape.

In the embodiment illustrated in FIGS. 8 and 9, the beverage dispenser includes a mesh trap 254 or wire filter at the liquid output portion that prevents the discrete flavor preserver 210 elements or beads from being expelled with the beverage 256 as the liquid level becomes low. The mesh restricts the beads 256 from being dispensed or expelled along with the beverage 256. It should be appreciated that the mesh trap 254 may also be a different filter or other mechanism that would effectively restrict the beads from being expelled to the consumer's cup or beverage collector.

Therefore, the beads 252 or other discrete elements function as a flavor preserver 210 and reduce the surface area of the beverage 256 exposed to the atmosphere in the head space 240 above the liquid. Therefore, the flavor preserver 210 preserves the flavor of the tea, brewed beverage, or other beverage for a greater period of time.

4. Flavor Preserver in a Sheet Form

In one embodiment, the flavor preserver includes a flexible membrane, skin, film or sheet that is configured to float atop the beverage surface, as described above. The flexible sheet may be relatively thin and can be sold as a disposable item. The flexible sheet also has substantially the same shape as that of the beverage container so as to cover a substantial portion of the beverage surface. The sheet may be foldable in order to be packaged in a compact form. In an example, one of the disposable sheets can be removed from the package, unfolded, and inserted into the beverage container. Because the sheet floats on top of the beverage surface, it provides a physical barrier between the beverage and the atmosphere to reduce the rate of flavor loss of the beverage.

5. Other Applications of the Flavor Preserver

In other embodiments, the flavor preserver is configured to be used with a portable beverage container usable directly by the consumer of the beverage. The portable beverage container can be any suitable container such as a drinking cup, bottle, mug or can, whether disposable or reusable. The flavor preserver used in such containers can have any of the shapes and characteristics described in the various embodiments above. In one embodiment, a drinking or beverage container includes a flavor preserver, and a straw integrally formed into a sidewall of the beverage container. The straw extends to the bottom or base of the beverage container enabling the user to draw the beverage from below the flavor preserver. In another embodiment, the drinking or beverage container includes a tipper (such a line, chord, rod or chain as described above) coupled to the flavor preserver to facilitate pouring additional beverage into or out of the beverage container.

6. Chemical Flavor Preserver

In one embodiment, the flavor preserver may be a chemically-based flavor preserver in a liquid form or a gaseous form. Where the flavor preserver is a liquid barrier, the chemical additive is added to the beverage container along with the brewed beverage. The liquid additive can be immiscible with the consumable beverage and also has a lower density than the beverage. By having a lower density, the liquid additive floats to the top of the beverage and forms a discrete liquid layer. The liquid additive forms a physical barrier between the beverage and the atmosphere in the head space above the beverage. The liquid additive is, in one embodiment, substantially odorless, tasteless, and suitable for use with a consumable beverage.

In one embodiment where the flavor preserver is a liquid additive, the beverage dispenser includes a level control device or mechanism that functions to reduce the likelihood of the beverage from falling below a certain minimum level. That is, because the liquid additive is less dense than the beverage and floats on top of the beverage, setting a minimum beverage level would reduce the potential for the beverage to be expelled or dispensed through an outlet valve or other dispensing mechanism. In one example, the beverage outlet may include an inverted u-shaped tube. This u-shaped tube would provide an amount of hydrostatic pressure that would restrict the liquid level in the beverage container from falling below a specified level. That is, the height of the top portion of the u-shaped tube would substantially correlate to the minimum liquid level in the beverage container. Therefore, the u-shaped tube would reduce the likelihood that the liquid additive flavor preserver would be dispensed to a consumer. The u-shaped tube would also advantageously reduce any sediment (i.e., sediment from a brewed beverage such as tea or coffee) that has accumulated in the bottom of the beverage container from being dispensed to the consumer.

In an embodiment, the flavor preserver is a gas or gaseous mixture that is introduced or otherwise sealed in the beverage container. In one example, a gas such as nitrogen is introduced or inserted into the beverage container. The nitrogen expels and substantially replaces the atmospheric gas that is normally in contact with the surface of the beverage. Therefore, the nitrogen reduces any chemical reaction that would have occurred by the interaction of the atmosphere gaseous components with the beverage. To the extent that an atmospheric gas such as oxygen causes an oxidation or other chemical reaction that results in flavor or nutrient loss of the beverage, the reduction in oxygen content in the head space above the beverage will reduce the flavor or nutrient losses of the beverage. Similarly, the physical embodiments discussed above (such as the disc shaped or piston shaped flavor preserver) would provide for a similar flavor preservation effect. That is, the flavor preservers of these embodiments provide a physical barrier between the beverage and the oxygen or other atmospheric gases in the head space of the beverage container.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A beverage surface cover for use in conjunction with a beverage dispensing apparatus, the beverage dispensing apparatus having a reservoir, the reservoir having an inner diameter and sized to hold a supply of a beverage having a beverage surface, the beverage surface cover comprising:
a body having a top surface, a bottom surface, and a side wall surrounding the body, the body having a diameter defined by the side wall, the diameter of the body being less than the inner diameter of the reservoir, the bottom surface configured to cover a portion of the beverage surface, the coverage of the beverage surface being associated with a degree of preservation of flavor of the beverage.

2. The beverage surface cover of claim 1, wherein the body has a buoyancy characteristic.

3. The beverage surface cover of claim 1, including at least one gripper coupled to the body.

4. The beverage surface cover of claim 1, including at least one handle coupled to the body.

5. A method of preserving a flavor of a beverage, the method comprising:
inserting a beverage surface cover into a beverage container which contains a brewed beverage enabling the beverage surface cover to float on a surface of the brewed beverage,
wherein the beverage surface cover remains floating on the surface as of the brewed beverage as the level of the surface changes.

6. The method of claim 5, wherein the beverage surface cover covers substantially all of the surface of the beverage.

7. The method of claim 5, including providing a gripper coupled to the beverage surface cover to facilitate removal of the beverage surface cover from the beverage container.

8. A beverage dispensing apparatus comprising:
a beverage container including a fluid input area and a fluid output area, the beverage container sized to hold a beverage having a beverage surface;
a dispenser connected to the fluid output area; and
a flavor preserver insertable into the beverage container, a portion of the flavor preserver being positionable on top of the beverage surface, the flavor preserver reducing exposure of at least a portion of the beverage surface to air, the flavor preserver being movable in response to a change in a level of the beverage.

9. The beverage dispensing apparatus of claim 8, wherein the flavor preserver is a substantially disk shaped piston having a surface area substantially equal to a surface area of the beverage.

10. The beverage dispensing apparatus of claim 9, wherein the diameter of the disk shaped piston is less than a diameter of the beverage container.

11. The beverage dispensing apparatus of claim 10, wherein the piston has a buoyancy characteristic and which is floatable on the beverage surface.

12. The beverage dispensing apparatus of claim 9, wherein the piston includes an annular groove around the perimeter of the piston.

13. The beverage dispensing apparatus of claim 12, which includes an o-ring in the annular groove of the piston.

14. The beverage dispensing apparatus of claim 8, including a drive mechanism controlled by a processor and coupled to the flavor preserver.

15. The beverage dispensing apparatus of claim 14, wherein the flavor preserver includes a plurality of substantially spherical elements at least substantially covering the surface area of the beverage.

16. The beverage dispensing apparatus of claim 8, wherein the flavor preserver is a liquid having a density less than a density of the beverage and that is immiscible with the beverage.

17. A beverage dispensing apparatus comprising:
a container having an inner wall with a diameter, the container sized to hold a beverage having a beverage surface;
a beverage outlet connected to the container; and
a cover movably positioned within the container, the cover having a diameter less than the diameter of the inner wall of the container, the cover being:
(a) movable between a plurality of positions associated with different levels of the beverage in the container;
(b) positioned adjacent to the beverage surface in each one of the positions; and
(c) configured to cover a portion of the beverage surface, the coverage of the beverage surface being associated with a degree of preservation of flavor of the beverage.

18. The beverage dispensing apparatus of claim 17, wherein the inner wall defines a shape selected from the group consisting of a circular shape, an oval shape, a polygonal shape, a square shape, and a rectangular shape.

19. The beverage dispensing apparatus of claim 17, wherein the cover has a buoyancy characteristic with respect to the beverage.

20. The beverage dispensing apparatus of claim 17, wherein the cover is configured to cover substantially all of the beverage surface.
